(19) United States
(12) Patent Application Publication
(10) Pub. No.: US 2007/0174802 A1
(43) Pub. Date: Jul. 26, 2007

(54) METHOD OF ADJUSTING PATTERN DENSITY

(76) Inventors: Jae-Pil SHIN, Suwon-si (KR); Moon-Hyun Yoo, Suwon-si (KR); Jong-Bae Lee, Yongin-si (KR); Jin-Sook Choi, Suwon-si (KR); Sung Gyu Park, Suwon-si (KR)

Correspondence Address: Frank Chau, Esq.;F. CHAU & ASSOCIATES, LLC, 130 Woodbury Road, Woodbury, NY, 11797, US

(21) Appl. No.: 11/625,569

(22) Filed: Jan. 22, 2007

(30) Foreign Application Priority Data
Jan. 23, 2006 (KR) 2006-06882

(51) Int. Cl. G06F 17/50

(52) U.S. Cl. 716/8; 716/1

(57) ABSTRACT

A method of adjusting pattern density includes determining a reference pattern density, defining dummy generation fields and designed patterns, forming basic dummy patterns on the dummy generation fields, evaluating a total pattern density from a sum of a density of the designed patterns and a density of the basic dummy patterns, adjusting a size of the basic dummy patterns so that the total pattern density reaches the reference pattern density, and combining data of the adjusted dummy patterns with data of the designed patterns.

### CROSS-REFERENCE TO RELATED APPLICATION

This application claims priority under 35 U.S.C. §119 to Korean Patent Application No. 2006-006882, filed on Jan. 23, 2006, the disclosure of which is incorporated herein by reference in its entirety.

### BACKGROUND

1. Technical Field

The present disclosure relates to a method of adjusting a pattern density in a semiconductor device, and more particularly to a method of adjusting a pattern density in a semiconductor device for minimizing pattern deformation.

2. Discussion of Related Art

In fabricating a semiconductor device, operational characteristics of electronic circuits can be affected by the line widths of circuit patterns,. The line widths of circuit patterns are determined by photolithography and etching processes during the manufacture of a semiconductor device. The line widths of circuit patterns may be inconsistent throughout the semiconductor device due to an irregular density of circuit patterns. For instance, when a global pattern density (GPD), i.e., a patterns density of an entire chip area, changes in the range of 1%, the line widths, of patterns change through the photolithography and etching processes about 1.6 nm and about 1.3 nm, respectively.

To control the line widths of circuit patterns, photolithography and etching processes are performed in an optimum circumstance by altering processing conditions whenever a product with a certain GPD is used. Thus, optimum parameters from altering processing conditions in accordance with kinds of products need to be established. However, a time variation can occur even with the optimally established processing conditions. As a result, the process stability can be lowered, and distributions of pattern densities can be widened, thereby reducing processing margins.

### SUMMARY OF THE INVENTION

Exemplary embodiments of the present invention provide a method of adjusting a pattern density in a semiconductor device. The method of adjusting a pattern density can minimize distribution of global pattern densities and conduct a process in an optimum condition when a product type is changed.

The method of adjusting a pattern density may provide a global pattern density for rendering a process conducted under an optimum processing condition.

The method of adjusting a pattern density may minimize gaps of designed pattern densities over a chip area, thereby providing the optimum global pattern density.

According to an exemplary embodiment of the present invention, a method of adjusting pattern density includes determining a reference pattern density, defining dummy generation fields and designed patterns, forming basic dummy patterns on the dummy generation fields, evaluating a total pattern density from a sum of a density of the designed patterns and a density of the basic dummy patterns, adjusting a size of the basic dummy patterns so that the total pattern density reaches the reference pattern density, and combining data of the adjusted dummy patterns with data of the designed patterns.

Defining the dummy generation fields and designed patterns may comprise enlarging the designed patterns in a predetermined rate and setting restrictive regions with spaces occupied by the enlarged designed patterns, and defining an area not occupied by the designed patterns and the restrictive regions as the dummy generation fields.

The restrictive regions may include design-inhibited regions preliminary defined during a procedure of design.

The basic dummy patterns may be spaced at a predetermined distance from boundaries of the dummy generation fields.

The method may further comprise establishing a maximum size corrected from a size of a basic dummy pattern, and isolating the basic dummy patterns from the boundaries of the dummy generation fields.

The basic dummy patterns can be isolated from each other.

Adjusting the size of basic dummy patterns may comprise evaluating a density of a corrected dummy pattern by subtracting the designed pattern density from the reference pattern density, determining a size of the corrected dummy pattern from the corrected dummy pattern density, and adjusting the basic density pattern size to the corrected dummy pattern size.

Determining the corrected dummy pattern size may comprise evaluating a total area of the corrected dummy patterns from the corrected dummy pattern density, evaluating an area of the dummy pattern from dividing the total area of the corrected dummy patterns by a number of the dummy patterns, and determining a 2-dimensional size of the corrected dummy pattern from the dummy pattern area.

According to an exemplary embodiment of the present invention, a method of adjusting pattern density includes determining a reference pattern density, defining dummy generation fields and designed patterns, forming basic dummy patterns on the dummy generation fields, dividing a chip area into a plurality of subareas, evaluating a total pattern density of each subarea from a sum of a density of the designed patterns and a density of the basic dummy patterns, adjusting a size of the basic dummy patterns so that the total pattern density of each subarea reaches the reference pattern density, and combining data of the adjusted dummy patterns with data of the designed patterns.

Defining the dummy generation fields and design patterns may comprise enlarging the designed patterns in a predetermined rate and setting restrictive regions with spaces occupied by the enlarged designed patterns, and defining an area not occupied by the restrictive regions and the designed patterns as the dummy generation fields.

The restrictive regions may include design-inhibited regions preliminarily defined during a procedure of design.

The method may further comprise establishing a maximum size corrected from a size of the basic dummy pattern, and isolating the basic dummy patterns from boundaries of the dummy generation fields.

The basic dummy patterns can be isolated from each other.

Adjusting the size of the basic dummy patterns may comprise evaluating a density of corrected dummy pattern by subtracting the designed pattern density from the reference pattern density, determining a size of the corrected dummy pattern from a target density of the corrected dummy patterns, and adjusting the basic dummy pattern size to the corrected dummy pattern size.

Determining the corrected dummy pattern size may comprise evaluating a total area of the corrected dummy patterns from the corrected dummy pattern density, evaluating an area of the dummy pattern from dividing the total area of the corrected dummy patterns by a number of the dummy patterns, and determining a 2-dimensional size of the corrected dummy pattern from the dummy pattern area.

### BRIEF DESCRIPTION OF THE DRAWINGS

Exemplary embodiments of the present disclosure can be understood in more detail from the following description taken in conjunction with the accompanying drawings of which:

FIG. 1 is a flow chart showing a method of adjusting pattern density in accordance with an exemplary embodiment of the present invention;

FIGS. 2 through 5 are plan views illustrating a method of adjusting a pattern density, according to an exemplary embodiment of the present invention;

FIG. 6 is a flow chart showing a method of adjusting a pattern density in accordance with an exemplary embodiment of the present invention; and

FIGS. 7 and 8 illustrate a method of adjusting a pattern density in accordance with an exemplary embodiment of the present invention.

### DETAILED DESCRIPTION OF EXEMPLARY EMBODIMENTS

Exemplary embodiments of the present invention will be described in more detail with reference to the accompanying drawings. The present invention may, however, be embodied in many different forms and should not be construed as limited to the embodiments set forth herein.

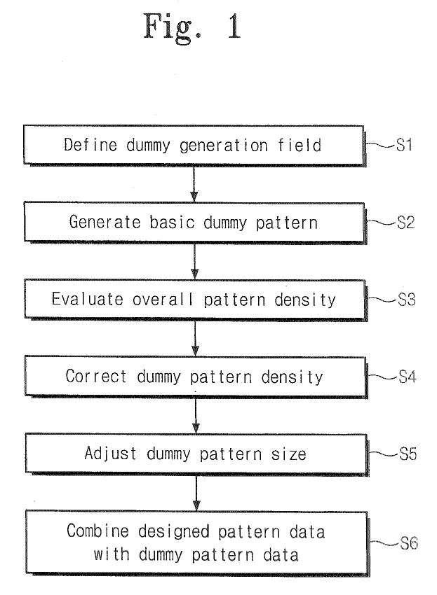

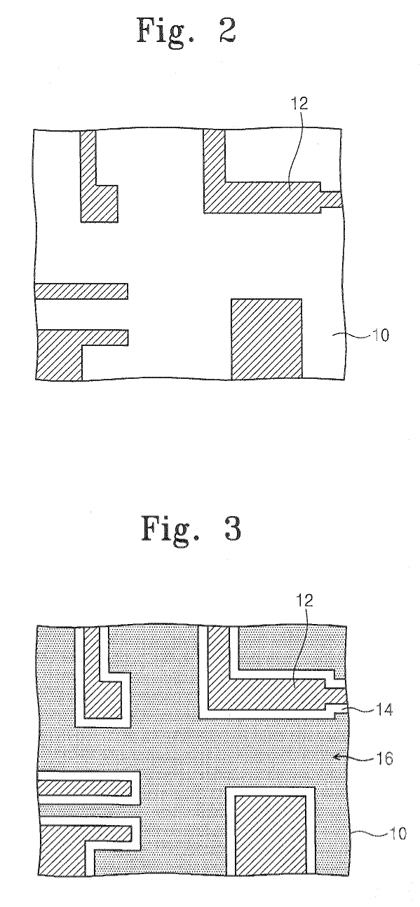

FIG. 1 is a flow chart showing a method of adjusting a pattern density in accordance with an exemplary embodiment of the present invention. FIGS. 2 through 5 are plan views illustrating a method of adjusting a pattern density according to an exemplary embodiment of the present invention.

Referring to FIG. 1, step S1 defines a dummy generation field in a chip area. The chip area refers to a virtual chip area provided for a photomask, not an area formed on a wafer. Referring to FIG. 2, designed patterns 12 for constituting circuits are arranged in a virtual chip area 10. The designed patterns 12 are disposed in accordance with predetermined data for a circuit design. Referring to FIG. 3, dummy generation fields 16 are disposed on the virtual chip area 10 other than the fields occupied by the designed patterns 12. The dummy generation fields 16 are isolated from the designed patterns 12 by predetermined distances. Dummy patterns are formed on the dummy generation field 16. If the dummy patterns are located near the designed patterns 12, the designed patterns 12 may be deformed by optical characteristics such as a proximity effect. Thus, regions within a predetermined distance from the designed patterns 12 may be specified as restrictive regions 14. The designed patterns 12 are isolated from the dummy patterns using the restrictive regions 14 to prevent the designed patterns 12 from deformation.

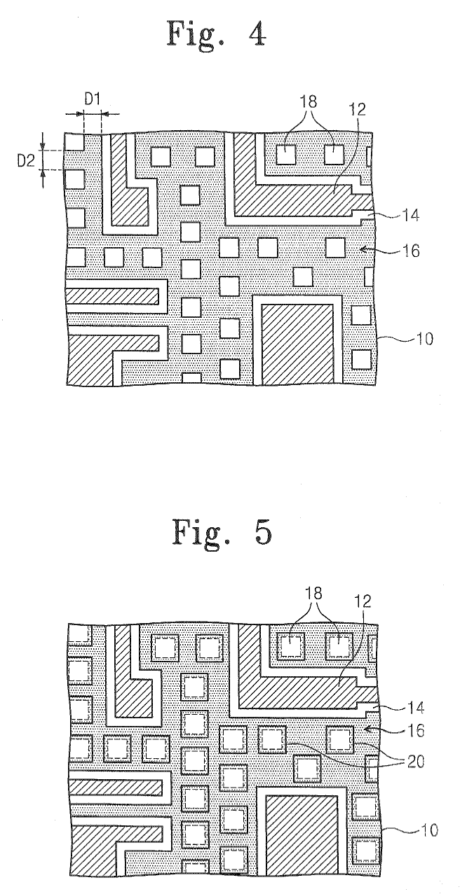

Referring to step S2 and FIG. 4, basic dummy patterns 18 are formed on the dummy generation fields 16. The basic dummy patterns 18 may be formed in the shape of, for example, a square to measure an area and a size alteration of the areas. The basic dummy patterns 18 may be formed in different shapes. The dummy patterns to be formed on the dummy generation fields 16 may be formed in various configurations. A size of the dummy pattern to be formed may be preliminarily established in a range defined by a photolithography process. The size of the basic dummy pattern 18 may be selected such that a size of the dummy pattern with the highest frequency of use can be adopted.

The basic dummy patterns 18 are arranged at a predetermined distance D1 from the boundaries of the dummy generation fields 16 and arranged at a predetermined distance D2 from adjacent dummy patterns. These distances D1 and D2 are determined considering that dummy patterns to be formed should not overlap other adjacent dummy patterns in an occupation area while remaining in the dummy generation fields 16. Therefore, the distances D1 and D2 can be determined considering that a size of the dummy pattern to be formed on the dummy generation field 16 is the largest dummy pattern. To maintain the distances D1 and D2 from the boundaries of the dummy generation fields 16 and the adjacent dummy patterns, the conditions for forming the basic dummy patterns 18 should be satisfied.

Step S3 is performed to evaluate pattern densities of the chip area in which the designed patterns 12 and the basic dummy patterns 18 are formed.

The pattern density of the designed patterns 12 can be evaluated in an areal percentage of the designed patterns 12 to the chip area 10. The pattern density of the basic dummy patterns 18 can be evaluated as a percentage of an areal sum of the basic dummy patterns 18 to the chip area 10. The areal sum of the basic dummy patterns 18 is obtained from multiplying an area of the basic dummy patterns 18 by the number of the basic dummy patterns 18. Thus, as summarized in Equation 1, the total pattern density Dₜₒₜₐₗ is represented as a sum of the pattern density of the designed patterns 12, D_{design}, and the pattern density of the basic dummy patters 18, D_{dummy}.

$$\begin{matrix}{D}_{total} = {D}_{design} + {D}_{dummy} \\ = \frac{{A}_{design}}{{A}_{total}} S100 ( \% ) + \frac{{A}_{dummy}}{{A}_{total}} S100 ( \% )\end{matrix} \qquad \text{[Equation 1]}$$

### Here, the capital letter D represents a pattern density and the capital letter A represents an area.

The suffixes ₜₒₜₐₗ, _{design}, and _{dummy} denote the whole chip area, the designed patterns, and the dummy patterns, respectively.

In step S4, the pattern density of the dummy patterns is corrected to make the total pattern density reach a reference pattern density. The reference pattern density may be set in a global pattern density. The optimum performance to a designed circuit with the least deformation of a line width after photolithography and etching processes can be performed in the global pattern density.

Thus, the corrected pattern density of the dummy patterns, as given by Equation 2, is obtained from a sum of the reference pattern density and a gap between the reference pattern density and the total pattern density.

D_{dummy′}=D_{target}−Dₜₒₜₐₗ+D_{dummy} [Equation 2]

### Here, the suffix _{target} represents the reference patterns and the suffix _{dummy′} represents the corrected dummy patterns.

Referring to step S5 and FIG. 5, the basic dummy patterns are adjusted in size through abstracting correction values from the corrected data of the dummy pattern density. When the basic dummy pattern 18 is shaped in a square, dimensions of the basic dummy patterns 18 along X and Y directions are correspondent with the square root of an area. An area of the basic dummy patterns 18 can be obtained from the pattern density and number of the basic dummy patterns 18.

Equation 3 is given for obtaining the dimensions of the corrected dummy patterns 20 from the corrected pattern density of dummy patterns. An occupation area of the corrected dummy patterns, A_{dummy′}, results from multiplying the total area Aₜₒₜₐₗ by the corrected dummy pattern density D_{dummy′}. A value obtained from dividing the corrected dummy pattern occupation area A_{dummy′} by the number of dummy patterns is a unit area S_{dummy′} of the corrected dummy pattern.

$$\begin{matrix}{W}_{{dummy}^{′}} = \sqrt{{S}_{{dummy}^{′}}} = \sqrt{\frac{{A}_{{dummy}^{′}}}{N}} \\ = \sqrt{\frac{{A}_{total} {SD}_{{dummy}^{′}}}{N}}\end{matrix} \qquad \text{[Equation 3]}$$

### Here, the capital letters W, S, and N denote a width of a pattern, an area of a pattern, and a number of dummy patterns, respectively.

A unit dimension (i.e., line width) of the dummy pattern, W_{dummy′}, for matching the global pattern density with the reference pattern density, can be evaluated in the square root of the unit area of the corrected dummy pattern 20. When the total pattern density is less than the reference pattern density, the basic dummy patterns 18 are enlarged to be the corrected dummy patterns 20 as illustrated in FIG. 5. Wherein the total pattern density is higher than the reference pattern density, the basic dummy patterns 18 can be shrunken to be smaller corrected dummy patterns.

In step S6 of FIG. 1, a resultant photomask is fabricated through combining data of the corrected dummy patterns 20 with data of the designed patterns 12. The photomask fabricated by combining data of the corrected dummy patterns 20 with data of the designed patterns 12 is arranged with a global pattern density close to the reference (or target) pattern density, which minimizes variation of a line width in a photolithography process and lessens variation after an etching process.

Exemplary embodiments of the present invention provide a method of adjusting the dimensions of the dummy patterns so that the total pattern density can be the reference pattern density by presetting the reference pattern density with a global pattern density of chip area which provides the optimum processing condition.

Therefore, exemplary embodiments of the present invention can be applied to a product with lower distribution of pattern densities by fields on the chip area or a case required of rendering the total pattern density, rather than distribution of the global pattern density, close to the optimum reference pattern density.

According to an exemplary embodiment of the present invention, a pattern density substantially close to the reference pattern density can be obtained by forming the dummy patterns in consideration of the whole chip area. The distribution of pattern densities by fields on the chip area may be enlarged by disposing dummy patterns of the same size all over the chip area.

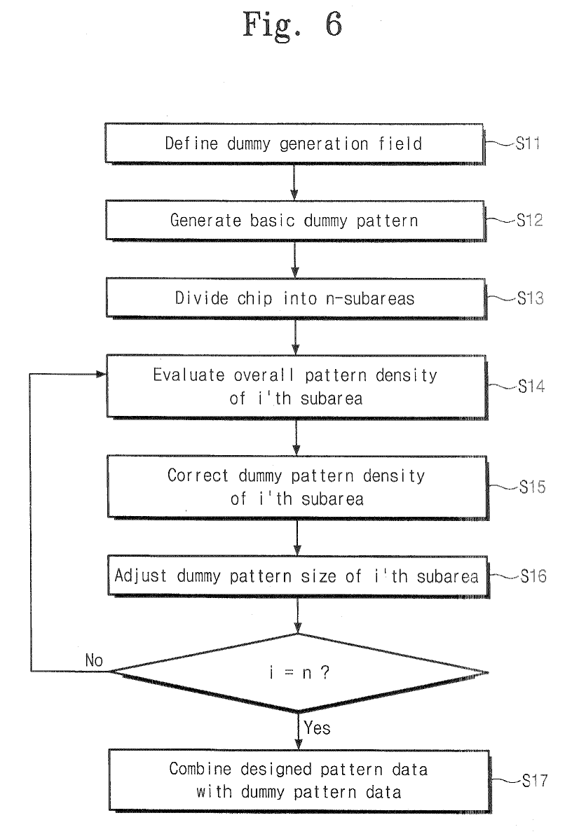

FIG. 6 is a flow chart showing a method of adjusting a pattern density in accordance with an exemplary embodiment of the present invention, in which the chip area is divided into a plurality of subareas and a pattern density of each subarea is controllable.

Through steps S11 and S12, dummy generation fields are defined in a chip area 50 like the aforementioned steps S1 and S2 and basic dummy patterns are formed on the dummy generation fields.

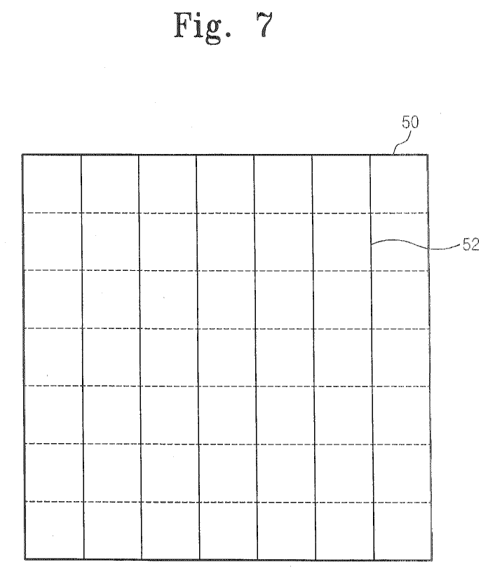

Referring to step S13 of FIG. 6 and FIG. 7, the chip area 50 is divided into subareas in the number of n. The subareas 52 may be arranged in a matrix in the chip area 50 shown in FIG. 7 and segmented from regions that are substantially distinguished in pattern densities. For instance, a memory apparatus has a substantial difference of pattern densities between a cell array region and a peripheral region. Thus, the distribution according to pattern densities can be reduced by arranging the subareas differently in the cell array and peripheral regions.

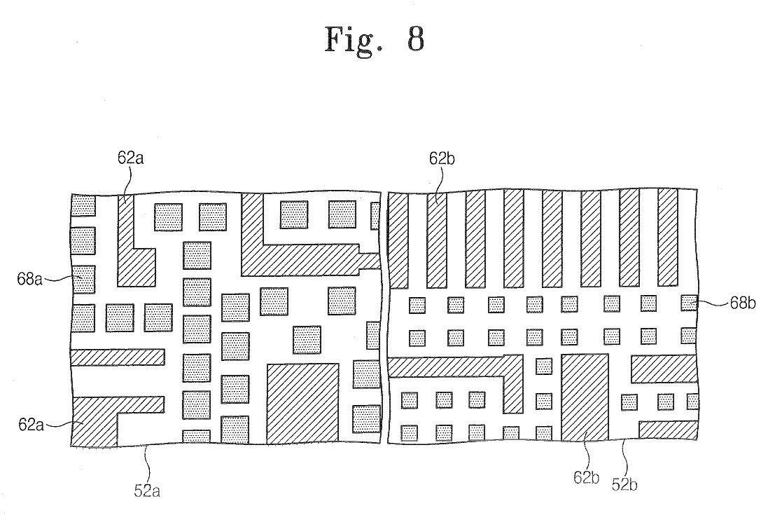

Then, referring to steps S14 through S16 of FIG. 6 and FIG. 8, the dummy patterns, are sequentially adjusted in size on the divided subareas 52 shown in FIG. 7 such that a pattern density of the subarea is close to the reference pattern density. Referring to FIG. 8, in a first subarea 52a, first designed patterns 62a with a lower patterns density are formed, and in a second subarea 52b, second designed patterns 62b wall a higher pattern density are formed. Comparing the first subarea 52a and the second subarea. 52b, first dummy patterns 68a arranged in the first subarea 52a are relatively larger than second dummy patterns 68b arranged in the second subarea 52b in size. Thus, a pattern density of the first dummy patterns 68a is higher than that of the second dummy patterns 68b, resulting in equilibrium between the total pattern densities, of the first and second subareas 52a and 52b. If the first dummy patterns 68a are formed in the second subareas 52b, a gap of the total pattern densities between the first and second areas 52a and 52b may be larger due to an extension of regions incapable of accommodating the first dummy patterns 68a because the dummy generation fields of the second subarea 52b is narrow in width.

In step S17 shown in FIG. 6, after completing sequential adjustment to the dummy patterns of the last n'th subarea in size from the first subarea 52a, a resultant photomask is fabricated by combining data of the designed patterns with data of the dummy patterns.

Exemplary embodiments of the present invention provide a method to fabricate a photomask capable of minimizing deformation of patterns under a stable processing condition. Since a method according to exemplary embodiments of the present invention is applicable to products even different from each other in a designed pattern density, a photomask with the global pattern density optimized to any product can be provided. As a result, there is no need of changing processing conditions whenever each of products different in global pattern density is used in the photolithography and etching processes. The photolithography and etching processes can be performed, regardless of kinds of products, in accordance with the optimum processing conditions. Therefore, the stability of processing can be obtained along with an increase of processing margins.

Although exemplary embodiments have been described with reference to the accompanying drawings, it is to be understood that the present invention is not limited to these precise embodiments but various changes and modifications can be made by one skilled in the art without departing from the spirit and scope of the present invention. All such changes and modifications are intended to be included within the scope of the invention as defined by the appended claims.

What is claimed is:

1. A method of adjusting pattern density, comprising:
determining a reference pattern density;
defining dummy generation fields and designed patterns;
forming basic dummy patterns on the dummy generation fields;
evaluating a total pattern density from a sum of a density of the designed patterns and a density of the basic dummy patterns;
adjusting a size of the basic dummy patterns so that the total pattern density reaches the reference pattern density; and
combining data of the adjusted dummy patterns with data of the designed patterns.

2. The method of claim 1, wherein defining the dummy generation fields and designed patterns comprises:
enlarging the designed patterns in a predetermined rate and setting restrictive regions with spaces occupied by the enlarged designed patterns; and
defining an area not occupied by the designed patterns and the restrictive regions as the dummy generation fields.

3. The method of claim 2, wherein the restrictive regions include design-inhibited regions preliminarily defined during a procedure of design.

4. The method of claim 1, wherein the basic dummy patterns are spaced at a predetermined distance from boundaries of the dummy generation fields.

5. The method of claim 4, further comprising:
establishing a maximum corrected size from a size of a basic dummy pattern; and isolating the basic dummy patterns from the boundaries of the dummy generation fields.

6. The method of claim 5, wherein the basic dummy patterns are isolated from each other.

7. The method of claim 1, wherein adjusting the size of basic dummy patterns comprises:
evaluating a density of corrected dummy pattern by subtracting the designed pattern density from the reference pattern density;
determining a size of the corrected dummy pattern from the corrected dummy pattern density; and
adjusting the basic dummy pattern size to the corrected dummy pattern size.

8. The method of claim 7, wherein determining the corrected dummy pattern size comprises:
evaluating a total area of the corrected dummy patterns from the corrected dummy pattern density;
evaluating an area of the dummy pattern from dividing the total area of the corrected dummy patterns by a number of the dummy patterns; and
determining a 2-dimensional size of the corrected dummy pattern from the dummy pattern area.

9. A method of adjusting pattern density, comprising:
determining a reference pattern density;
defining dummy generation fields and design patterns;
forming basic dummy patterns on the dummy generation fields;
dividing a chip area into a plurality of subareas;
evaluating a total pattern density of each subarea from a sum of a density of the designed patterns and a density of the basic dummy patterns;
adjusting a size of the basic dummy patterns so that the total pattern density of each subarea reaches the reference pattern density; and
combining data of the adjusted dummy patterns with data of the designed patterns.

10. The method of claim 9, wherein defining the dummy generation fields and design patterns comprises:
enlarging the designed patterns in a predetermined rate and setting restrictive regions with spaces occupied by the enlarged designed patterns; and
defining an area not occupied by the restrictive regions and the designed patterns as the dummy generation fields.

11. The method of claim 10, wherein the restrictive regions include design inhibited regions preliminarily defined during a procedure of design.

12. The method of claim 9, which further comprises:
establishing a maximum size corrected from a size of the basic dummy pattern; and
isolating the basic dummy patterns from boundaries of the dummy generation fields.

13. The method of claim 12, wherein the basic dummy patterns are isolated from each other.

14. The method of claim 9, wherein adjusting the size of the basic dummy patterns comprises:
evaluating a density of a corrected dummy pattern by subtracting the designed pattern density from the reference pattern density;
determining a size of the corrected dummy pattern from a targeted density of the corrected dummy patterns; and
adjusting the basic dummy pattern size to the corrected dummy pattern size.

15. The method of claim 14, wherein determining the corrected dummy pattern size comprises:
evaluating a total area of the corrected dummy patterns from the corrected dummy pattern density;
evaluating an area of the dummy pattern from dividing the total area of the corrected dummy patterns by a number of the dummy patterns; and
determining a 2-dimensional size of the corrected dummy pattern from the dummy pattern area.
